(19) United States
(12) Patent Application Publication
(10) Pub. No.: US 2007/0006700 A1
(43) Pub. Date: Jan. 11, 2007

(54) Food portioning and application system

(76) Inventor: Donald G. Lunghi, Hillsborough, CA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/175,802

(22) Filed: Jul. 5, 2005

(51) Int. Cl. B26D 7/00; B26D 7/20

(52) U.S. Cl. 83/167; 83/659

(57) ABSTRACT

A system for packaging slices from a slicer that slices food slices from a food log or log. Included is a conveyor conveying food slice receptacles (targets) and an applicator in the form of a Bomb Bay type receiving/dispensing grid. The grid includes opposing edges that define opposing hinges and the grid further includes paired grid halves respectively pivoted about their hinges. In a closed position the grid receives slices from the food log and in an open position dispenses the slices onto the targets of the conveyor. The grid includes vertical movements for controlling the position of the receiving surface receiving slices from the log, and lateral movements for varying the slice arrangement as between stacked and shingled arrangement, and for positioning such arrangements crossway of the conveyor for placement on the targets.

### FIELD OF THE INVENTION

This invention relates to food packaging and more particularly to an automated procedure for slicing logs or logs of food items (e.g. meat or cheese logs or whole muscle meats) and placing the slices in selected different arrangements (e.g. multiple slices that are stacked or shingled) and in such a selected arrangement, depositing the arrangement of slices precisely on or in a receptacle (e.g. a tray or bun for building a sandwich).

### BACKGROUND OF THE INVENTION

It is common to package trays of presliced meats such as bologna, ham, beef. chicken, turkey and the like. The product is either in whole muscle form or prepared first as elongate logs which are then sliced into desired thicknesses, e.g. suitable for sandwiches. The stacked or shingled arrangements may then be placed in trays which are sold as cutlets for prepared meals or wrapped for display and sale in grocery stores and the like. Alternatively, certain food outlets will sell a prepared sandwich and one or more slices may be placed on a bun which is then wrapped and displayed for sale e.g. in convenience stores.

In prior systems, logs are sliced and placed on one end of a first conveyor and that conveyor delivers the slices to a food product applicator at the second end. A second conveyor may move cross way to or in-line with the first conveyor at the second end and the applicator precisely transfers the individual stack or shingled slices from the conveyor onto or into buns and trays being conveyed by the second conveyor.

A problem of the operation described above is the need for the first conveyor. The food logs (e.g. of 3′ lengths and longer) are fed into the slicer in rapid succession. Nevertheless, there is a delay in the slicing operation, as one log is completely sliced, and the following log is fed into the slicer. A portion of the trailing end of the log is not square, i.e. the butt end and the tubular log length do not meet at a square corner but instead is rounded. This causes feeding problems, e.g. for the last inch or so of the log end. This trailing end portion is either removed and discarded before slicing or a special feed mechanism takes over for that last end portion. In either event, the slicing operation is momentarily halted or at least slowed.

Whereas it is desirable to provide constant movement of the receptacle conveyor (second conveyor), the first conveyor allows the slicer to build a supply of food slices on the first conveyor which enables feeding of the slices to the second or packaging conveyor during the change over between successive logs.

However, the first conveyor takes up substantial floor space, e.g. in an assembly plant, and it is desirable to eliminate that conveyor. Further, even if the first conveyor were eliminated, the applicators developed for deposit of the food slices from the first conveyor to the trays cannot simply be mounted on the slicer mechanism and what is still needed is an applicator which will receive the slices sequentially, build the stack or shingled arrangement, and directly deposit those stacked portions and slices onto the targeted trays or buns. Alternatively, manual intervention is required to properly place the portions on their desired target.

### BRIEF DESCRIPTION OF THE INVENTION

A first concern is the interruption of the feeding process when transitioning from log to log. This is being accommodated concurrently herewith by the filing of a companion application for patent. The present application will be directed to the provision of the applicator.

Several concerns were considered in the design of the applicator for receiving food slices from the slicing machine and depositing those slices into trays/buns conveyed past the slicer. It will be first appreciated that location proximity sensors continuously identify the precise location of the trays and buns (targets) on the moving conveyor and (via a controller) identify the target positions to the applicator.

The slices need to be neatly stacked or shingled when deposited on the targets and, for efficiency, the operation of slicing and depositing must be very rapid. The assumption here is that the meat logs are fed to the slicer with little or no interruption as the slicer transcends from log to log. To achieve the precision for deposit and neatness of the stacks or shingles, the preferred applicator incorporates a “Bomb Bay” type receiving grid. The grid is movable in the X, Y and Z axes. The Y axis allows the grid to move cross way to the conveyor to enable the grid to overlie different rows of targets. The X axis enables the grid to shift lengthwise relative to the conveyor which enables the grid to build shingled rather than stacked slices. The Z axis enables lowering of the grid to maintain a desired distance relative to the slicer during stacking. It is desired that the slices gravity fall from the slicer onto the grid or top most slice of a stack of slices from a short distance, e.g. about the thickness of a slice. The Z axis of movement enables the grid to accommodate that desire and to continuously shift up and down with each slice.

The X and Z movements of the grid provide for a neatly arranged stack and/or shingled arrangement of the slices and the Y axis enables positioning of the grid over multiple rows of targets. The application or deposit of the slices on the target tray or bun is accomplished by the Bomb Bay type release of the slices by the grid. The grid (in its preferred form) is in two parts and has hinge-like movement at opposed outer edges. The inner edges, in closed or receiving positions, are adjacent and define a center line of the grid to provide full support of the slices on the grid when closed. When the sliced food stack is to be deposited onto a tray or bun, the two parts of the grid are rapidly opened via the outer edge hinges and the slices are simply gravity dropped onto the tray/bun.

The invention will be more fully understood and appreciated upon reference to the following detailed description of the preferred embodiment and having reference to the drawings referred to therein.

### BRIEF DESCRIPTION OF THE DRAWINGS

FIG. 1 is a schematic side view of a slicer slicing slices off a meat log for deposit onto a receiving grid, and further illustrating a receiving conveyor, all in accordance with the invention;

FIG. 2 is a top view as taken on view lines 2-2 of FIG. 1;

FIG. 3 is a view similar to FIG. 1 but illustrating the deposit of slices by the grid onto the receiving conveyor;

FIGS. 4-7 are schematic views illustrating variations to the process of the apparatus as shown in FIGS. 1-3; and

FIGS. 8 and 9 are perspective views of the system shown schematically in FIGS. 1-3.

### DETAILED DESCRIPTION OF THE INVENTION

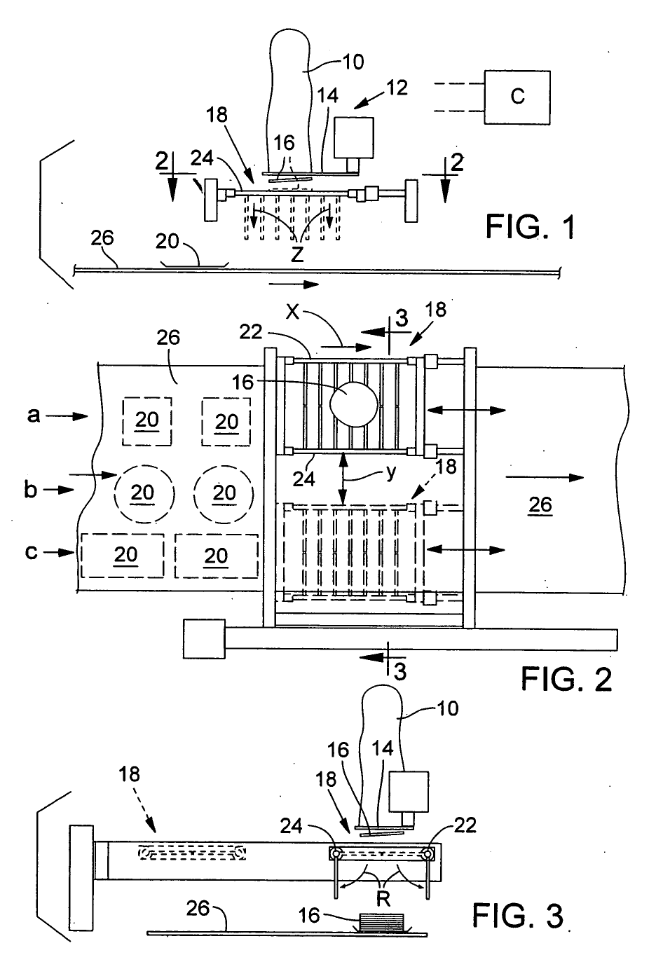

Reference is first made to FIGS. 1-3. In FIG. 1 a meat log or log is indicated as reference no. 10. A slicing machine 12 includes a pivoting or rotating blade 14 that slices through the log 10 to produce slices 16.

The slicing machine described is known and will not be illustrated or described in further detail. In a preferred embodiment, the log is gripped at opposed sides by feed conveyors and incrementally fed downward into the path of the blade 14. That is, the log is advanced downward by the desired thickness of a slice, the blade 14 is activated to cut through the log and thereby produce the slice 16 and that process is repeated over and over. Whereas, the schematic illustration of the log indicates that the log is advanced in the vertical direction and the blade pivoted through the log horizontally, it is common for the log to be in an angled position and the blade path angled accordingly. Either set up or arrangement will suffice for this application, but the vertical arrangement is preferred.

Attention is now directed to the grid mechanism 18 (sometimes hereafter referred to as “grid”) overlying a conveyor 26. (The term “grid” is used herein and is used in the art to indicate a planar receiving platform of whatever kind or shape.) The grid is provided with pivotal half portions 22, 24 which will be further explained. The grid mechanism 18 is provided with four different movements. Movement in the X direction provides the ability to deposit multiple slices on the grid in a shingled arrangement as will be further explained. Movement in the Y direction enables the grid to be shifted to alternate rows of targets 20 indicated as rows a, b and c being conveyed toward and under the grid 18 on the conveyer 26. Movement in the Z direction allows the grid 18 to be lowered as desired and including incrementally, e.g. so that the landing surface (either the grid itself or the topmost previous slice) will remain the same distance from the slicer. The fourth movement is rotation movement of the half portions 22, 24 indicated by arrows R in FIG. 3. A computer/controller that coordinates and controls the various movements is indicated schematically at C. Passing under the grid portion of grid mechanism 18 is the conveyor 26 which is preferably run at a set continuous speed.

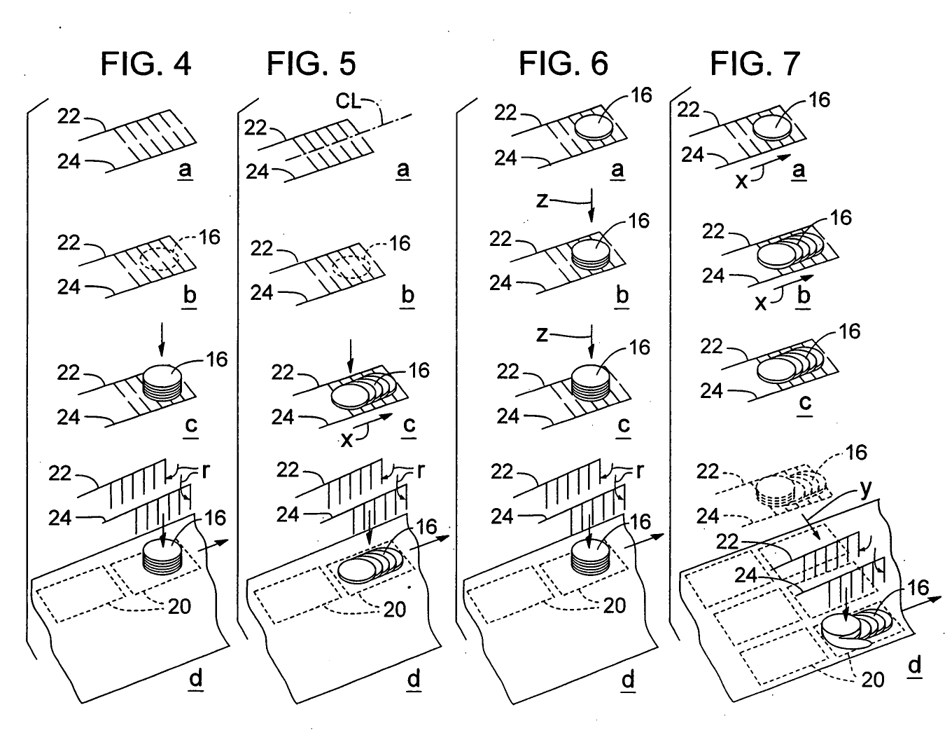

Reference is now directed to the process steps of FIGS. 4-7. In all of the process figures, only grid movement is illustrated. The various motors and support mechanism used in the processes, certain portions of which are schematically illustrated in FIGS. 1-3, are well known to the art and details thereof are not shown or described.

FIG. 4 assumes a desire to simply deposit one or several slices in a stack onto a receptacle in a common row, e.g., row a as seen in FIG. 2. FIG. 4a illustrates the grid portion halves 22, 24 only of grid mechanism 18. The grid is positioned under the slicer 12 and receives a desired number of slices 16 as indicated in FIG. 4c. FIG. 4d illustrates the targets 20 on which the stack of slices is to be placed. The two halves 22, 24 of the grid mechanism 18 are oppositely and rapidly pivoted as indicated by arrows R in response to the instructions of the controller C (FIG. 1). Such pivoting is faster than the gravity drop of the slices 16 to avoid interference and, accordingly, the stack of slices simply fall onto the target 20 passing under the grid mechanism.

It will be appreciated that the targets/receptacles can take many different forms and may include, e.g., buns, trays, pocket bread, paper wraps, webs, dough and the like. All such receptacles are herein collectively referred to and identified as targets 20.

FIG. 5 is differentiated from FIG. 4 by the utilization of movement X. As seen in FIGS. 5b and 5c, as each slice 16 is successively dropped onto the grid 18, the grid is moved in the X direction a small and specific increment to provide the shingled appearance as seen in FIG. 5c. The completed shingled slices 16 are arranged along the juncture or center line CL between the grid halves 22, 24, i.e. at the distal ends of the grid halves, and are similarly deposited onto the target 20 through rapid pivotal movement of the grid halves 22 and 24.

FIG. 6 illustrates the Z movement of the grid 18. As can be seen in FIG. 1, the grid 18 in the slice receiving mode is positioned to place/enable laying of the slice onto the grid as the slicing action proceeds. That is, initially the grid is spaced about double the thickness of the slice away from the blade. As the slice being cut starts to fall downwardly, it is received by the receiving surface before the cut of that slice is completed. This ensures a near perfect alignment of the slices in the stack. However, the next slice is placed on the top of the first slice (as shown in FIG. 1) and so on. To maintain the desired spacing, e.g., the thickness of a slice following each deposit of a slice, the grid is lowered by the thickness of that slice so that the receiving surface is the same distance from the blade. This incremental movement is represented in FIG. 6b by the arrow and reference letter Z. Again, upon completion of the slice count, and as calculated by, e.g., proximity sensors, controller C instructs opening of the grid halves for deposit of the stack onto a target 20 (FIG. 6c).

FIG. 7 illustrates all of the movements X, Y and Z. The desired arrangement of slices here is a combination of shingled and stacked slices. The slices are first shingled in response to movement X, then stacked with the height adjustment in accordance with the movement Z, and finally, following completion of the slice arrangement, the grid is shifted using movement y for aligning the slice arrangement over a target row. When the appropriate movement is attained, i.e. alignment with an underlying row, i.e., a select one of rows a, b or c, the grid halves are opened and the arrangement of slices is deposited on the target.

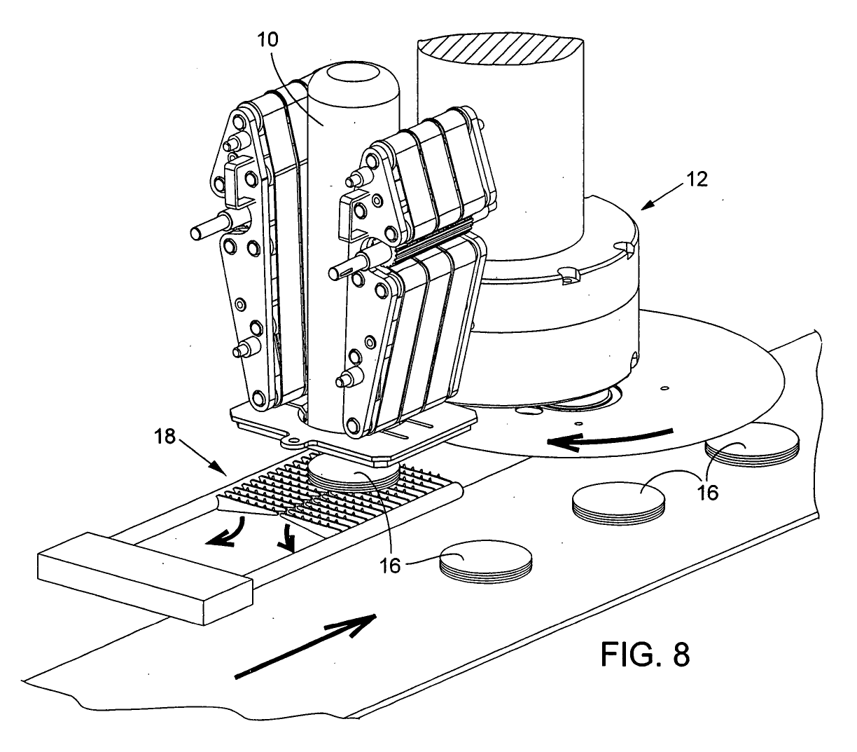

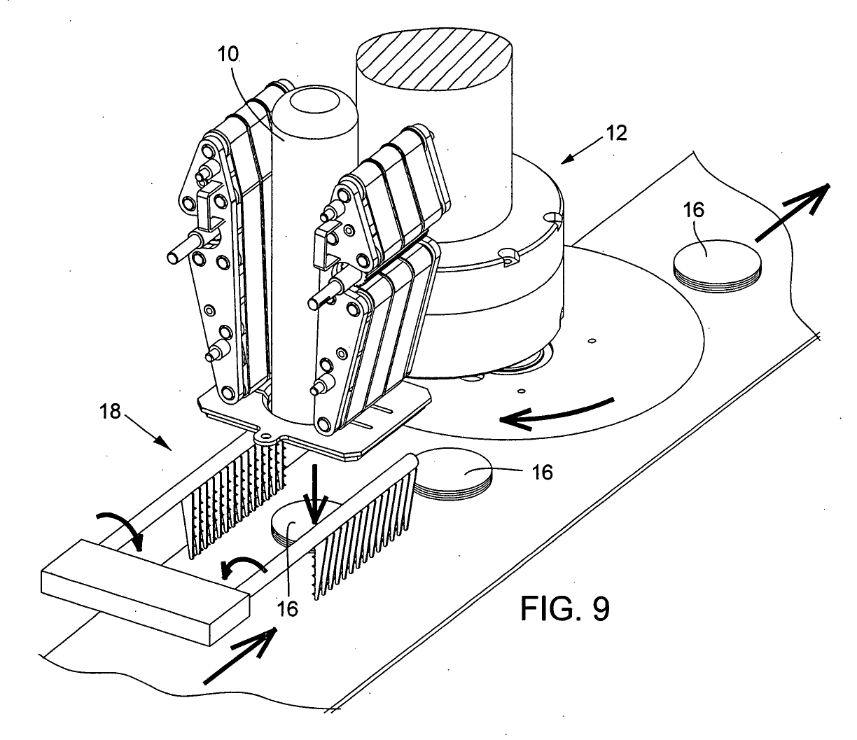

FIGS. 8 and 9 are provided to illustrate in greater detail the apparatus as schematically portrayed in FIGS. 1-7.

The above explanation with illustrations is believed to fully inform those skilled in the art in the practice of the invention. Such persons will further comprehend and conceive of numerous variations and improvements without varying from the scope of the invention. Accordingly, the claims and terms used in the claims are to be given their broad meaning consistent with the disclosure herein.

What is claimed is:

1. A food portioning and application system comprising:
a food log slicer arranged for slicing a food log into slices and as so arranged providing a slicing position and having gravity drop dispensing of said slices from said slicing position;
an applicator including a grid to receive said slices as dispensed from said slicer;
said grid having cooperative paired grid portions each including a hinged edge and a distal edge, said hinged edges permitting first and second opposing pivotal movement as between a receiving position with the distal edges pivoted upwardly into in adjacent relation for receiving slices, and downwardly into a dispensing position wherein said distal ends are cooperatively pivoted to allow gravity drop of the slices; and
a conveyor positioned for receiving slices from said grid with the grid portions in said dispensing position.

2. A system as defined in claim 1 wherein;
a controller controls operation of the grid;
said conveyer conveying spaced apart targets aligned for passage under said grid, said controller identifying the location of the targets and activating the movement of the grid for dispensing of the slices onto the targets conveyed by the conveyor.

3. A system as defined in claim 2 wherein the grid is provided with vertical movement, a defined receiving surface on which a slice is received by the grid and varying as subsequent slices and the upper surfaces of said slices define a new receiving surface, said vertical movement maintaining a desired spacing as between each receiving surface and the slicing position.

4. A system as defined in claim 2 wherein the grid is provided with a first lateral movement for movement of the receiving position incrementally and thereby placement of subsequent slices in a shingled arrangement.

5. A system as defined in claim 4 wherein the distal edges of the grid define a center line and the shingled arrangement of slices extends along said center line.

6. A system as defined in claim 2 wherein said grid is provided with a second lateral movement crossway to the conveyor movement, said second lateral movement providing alignment over targets on the conveyor at different crossway positions on the conveyor.

7. A system as defined in claim 6 wherein a plurality of rows of targets are provided on the conveyor and said second lateral movement of the grid selectively aligns the grid over selected ones of said plurality of rows.

8. A system as defined in claim 3 wherein the desired spacing is substantially the thickness of the slices being deposited on the grid.

9. A system as defined in claim 3 and further including selective first and second lateral movements of the grid, a first lateral movement lengthway of said conveyor movement for selective stacked and shingled arrangement of the slices and a second lateral movement crossway of said conveyor movement for selective alignment of the grid over targets conveyed by the conveyor.

10. A food portioning and application system comprising:
a food log slicer arranged for slicing a food log into slices and as so arranged providing a slicing position and having gravity drop dispensing of said slices from said slicing position;
an applicator including a grid to receive said slices as dispensed from said slicer;
said grid movable laterally during gravity drop dispensing of the slices from the slicer to provide a shingled arrangement of the slices on the grid;
said grid further movable downwardly and laterally from under the shingled arrangement of slices for gravity drop dispensing; and
a conveyor underlying said grid for receiving said slices in said shingled arrangement.

11. A food portioning and application system comprising:
a food log slicer arranged for slicing a food log into slices and as so arranged providing a slicing position and having gravity drop dispensing of said slices from said slicing position;
an applicator including a grid to receive said slices as dispensed from said slicer;
a conveyor underlying said grid and defining a direction of conveyance and conveying multiple targets at varying lateral positions on said conveyor; and
said grid movable laterally relative to said conveyor for alignment of said grid over said targets and for dispensing said slices onto said targets.

12. A food portioning and application system comprising:
a food log slicer arranged for slicing a food log into slices and as so arranged providing a slicing position and having gravity drop dispensing of said slices from said slicing position;
an applicator including a grid to receive said slices as dispensed from said slicer;
said grid receiving said slices dispensed from said log slicer and producing thereby a stack of said slices, and as received each top most slice defining a next slice receiving surface, said grid movable vertically to reposition the grid vertically and thereby maintain each next slice receiving surface at a constant spacing from said slicer.
